(19) United States
(12) Patent Application Publication
(10) Pub. No.: US 2006/0167985 A1
(43) Pub. Date: Jul. 27, 2006

(54) Network-distributed data routing

(76) Inventors: Michael J. Albanese, Los Gatos, CA (US); James Roland Henderson, Morgan Hill, CA (US); Keith Barraclough, Mountain View, CA (US); David Irvine, San Jose, CA (US)

Correspondence Address: Robert J. Crawford;Crawford Maunu PLLC, Suite 390, 1270 Northland Drive, St. Paul, MN, 55120, US

(21) Appl. No.: 11/056,345

(22) Filed: Feb. 11, 2005

Related U.S. Application Data
(63) Continuation-in-part of application No. 09/843,249, filed on Apr. 26, 2001.

(51) Int. Cl. G06F 15/16

(52) U.S. Cl. 709/203

(57) ABSTRACT

Data transfer over an network is effected in a manner that facilitates the use of available communications channels and makes possible enhanced data routing control and monitoring. According to an example embodiment of the present invention, data is transferred over a network having a plurality of communication links. A home (e.g., data source) node coupled to the network supplies data for transfer on the network. A network-distributed application routing controller is implemented at a host server and at the home node, and is configured for controlling the home node for passing data on the network. A data request from a remote network access appliance, such as a laptop or mobile telephone, is received at the host server. In response to the request, the host server implements the network-distributed application routing controller to transfer data from a home node to the remote network access appliance.

### RELATED PATENT DOCUMENTS

This application is a continuation-in-part of U.S. patent application Ser. No. 09/843,249 entitled “Data Routing Monitoring and Management,” filed Apr. 26, 2001, to which priority is claimed under 35 U.S.C. §120 for common subject matter.

### FIELD OF THE INVENTION

The present invention relates generally to communications and, more particularly, to data routing over network such as the internet.

### BACKGROUND OF THE INVENTION

Data communications over a variety of networks, such as Internet protocol (IP) networks, mobile telephone networks and others have increased at an astonishing rate over recent years. The affordability and availability of computers, telephones, wireless devices and other network access appliances has made their use prevalent in a variety of applications. Further, as the demand for network access devices has increased, the diversity in types of network access appliances has also increased, with different devices often implementing different protocols and performance-based operational characteristics.

As access to the Internet and other communications networks becomes easier, convenient and more readily available, these networks are increasingly used for applications involving the transfer of data such as images, audio, video and text. For example, data for computer software, music, video, news services, games and other applications is being requested and delivered via the Internet and, for many applications, via wireless networks such as those implemented for cellular telephone networks. Today, the number of network subscribers, data providers, and requests by those subscribers for data transfer, streaming data and other content are growing exponentially. In addition, the limitations of current systems restrict the ability to meet the demand in a reliable, secure, efficient and affordable manner.

Content (e.g., audio, images or video) has evolved in application and is readily stored electronically. For example, the storage of music in rewritable electronic media has become a popular method in which to maintain and access music collections. Another example involves video applications, where digital recording and storage of television and personal video collections has become popular. Photos are often stored and accessed electronically, instead of relying upon conventional printed photos and physical photo albums.

As the electronic storage of content and other data grows in popularity, access to the data as well as convenient manners in which to store the data and become increasingly important. For example, sales of music in downloadable audio formats are becoming increasingly popular. Digital audio players based in the home or office or mobile players that can be used in autos, laptop computers, personal listening devices and others are used for playback of this downloaded music. In order to play the music, audio data is loaded onto mobile players or local computers and used to locally play the music. Typically, the amount of storage space required for storing a large volume of audio data exceeds the memory capacity of digital audio players, computers or other appliances capable of playing music. In this regard, the management and use of audio, as well as other data such as image data and video data, has become increasingly burdensome in view of the demand for and use of this data.

As applied to conventional documents and other types of data (e.g., text-based documents, spreadsheets or presentations), the demand for flexible and efficient access to such data has also grown. For example, many workplaces have become increasingly mobile; employees are often working from a remote location such as at home or at traveling locations. Access to data from remote locations has been particularly useful for facilitating mobility while maintaining a desirable level of access to information. However, the growing size of data files desirably transferred to facilitate mobility or to otherwise provide flexible data access has presented challenges to the delivery of such data over communications channels. For instance, email is generally limited in its ability to transfer large data files, such as audio, video, text and presentation files.

For many communication applications, the increase in use and lack of availability of data transfer requires the creative use of communications channels and data. To meet these and other data transfer needs, networks have been enhanced both in the ability to process larger quantities of data and in the ability to process data at a higher rate of speed. In addition, network access appliances have been improved to increase the speed at which data can be processed and transferred. However, as the demand for high quantity data transfer increases, these needs become more difficult to meet.

One challenge to data transfer on the Internet stems from the inflexibility of data transfer channels. For example, if a data supplier sells data to an end user via the Internet, the end user typically downloads the data using one of only a handful of download locations operated at the control of the supplier. This type of operation can be cumbersome and expensive because the data may have to travel a significant distance and thus take up more time and space in the communications network. In addition, the transfer of data is limited by the location of the download locations.

Another challenge to the effective transfer and management of data is related to the provision of data at an acceptable transfer rate (e.g., as related to bandwidth). Certain network access appliances are limited in their ability to process audio data at different speeds, either by their internal configurations or by the availability of network access. For instance, mobile (wireless) type network access appliances can be limited by the available connectivity to mobile networks. In addition, certain network appliances may be adaptable for wired and wireless communications, with their respective ability to access data being relatively higher (e.g., faster) via wired communications, relative to wireless; when these appliances are operating via wireless communications, they may be able to receive data at a lower speed, or bitrate.

Yet another challenge to data transfer and management stems from the existence of a myriad of different types of data, as well as different types of data access appliances. For example, a variety of different data types are implemented for storing audio files. Often, these data types are associated with a particular type of digital audio device that is being used for playback. In addition, with each data type, there are often different manners in which the data is stored, typically involving different levels of quality (e.g., with different playback bitrates). In this regard, a digital audio player must not only have access to data but also have access to data in a particular format.

Still another challenge to network data transfer involves the management of media rights associated with digital rights management (DRM). As discussed above, digital media such as audio or video can be purchased via electronic delivery. In order to inhibit and/or prevent copying, distribution or other unauthorized use of data, security precautions are taken. In some applications, these security precautions require specific approaches to enable playback, which can further exacerbate difficulties associated with data transfer and subsequent use (e.g., playback).

Effectively and efficiently managing data transfer via communication networks has been challenging in the face of the advancement of technologies and trade channels that use or could use network-based data transfer.

### SUMMARY OF THE INVENTION

The present invention is directed to approaches to data routing, management and associated applications. The present invention is exemplified in a number of implementations and applications, some of which are summarized below.

According to an example embodiment of the present invention, an approach to data routing involves the establishment of a communications route between a user's home data storage/processing arrangement and a remote network access appliance.

According to another example embodiment of the present invention, an internet-based routing server facilitates the delivery of content between a home network node and the remote network access appliance. A host application running at the routing server is configured for interacting with the remote network access appliance using an authentication approach to control the remote network access appliance's ability to access the home network node. When a remote network access appliance is authenticated for accessing a particular home network node, the host application interacts with a content application at the home network node to facilitate the transfer of content from the home network node to the remote network access appliance.

In one implementation, the routing server is a network-distributed routing server implemented in a network-based server node and in a plurality of home network nodes. Each home network node (e.g., where a home “node” may include two or more internet access appliances in a shared location) is assigned particular access characteristics. These access characteristics are used by remote network access appliances, typically those of an individual associated with the home network node, to access content at the home network node.

In another example embodiment of the present invention, a network communication system is adapted for communicating data between a home user-network node and a remote user-network node. The system includes a home user-network node configured and arranged to store data capable of being routed on the network. The system also includes a server node and a remote user-network node that is configured and arranged to receive data routed on the network. A network-distributed application routing controller is implemented in the home user-network node and in the server node. The server node controls routing functions at the home user-network node via the network-distributed application routing controller. In response to a request for data routing between the home user-network node and the remote user-network node, the network-distributed application routing controller verifies the request using security data provided via the request (e.g., by comparing user identification and/or password information in the request to stored user identification and/or password information). If applicable, the data is configured for routing on the network. Once ready for routing, the network-distributed routing controller controls the home-user network node and the server node for routing the requested data between the home user-network node and the remote user-network node.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention that follows in connection with the accompanying drawings, in which:

FIG. 1 is a system for routing data via an internet protocol network using a server-hosted interface access approach, according to an example embodiment of the present invention;

FIG. 1A shows a home network configuration involving a user application router implementation, according to another example embodiment of the present invention;

FIG. 1B shows a network-based server arrangement, according to another example embodiment of the present invention;

FIG. 2 is a flow diagram showing an approach to the communication of data for a peer-to-peer routing approach, according to another example embodiment of the present invention;

FIG. 3 is a system for routing content between a user's home network machine and the user's remote network access appliance, according to another example embodiment of the present invention;

FIG. 4 shows an implementation of a host server configured for data routing, according to another example embodiment of the present invention; and

FIG. 5 shows an implementation of a home network node configured for data routing, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of communications, and the invention has been found to be particularly suited for personal data (e.g., content) routing on a network such as the Internet. While the present invention is not necessarily limited to such applications, various aspects of the invention may be appreciated through a discussion of various examples using this context.

According to an example embodiment of the present invention, a peer-to-peer network routing system is configured for selectively communicating personal data between a home network node and a user at a remote network access appliance via which the user has been granted access to the home network node. The home network node typically includes, e.g., a personal computer, set top box, web camera, secure monitoring system and/or content storage system at a home or business location with network (e.g., internet) access. In this context, a “user” at a remote network access appliance may include one or more individuals, such as members of a household, employees of a business entity or simply an individual given access authorization by a user associated with the home network node. Further, a “user” may be a machine automatically functioning, e.g., as programmed by an individual.

A host server provides a personal network service that connects a user, with software implemented at a home network node, to content available at the home network node. The host server facilitates an intelligent interface accessible by the network access appliance and further facilitates the selection and delivery of data, such as audio, image or video data, from the home network node to the network access appliance. A user at the remote network access appliance is thus connected to a home network node in the sense that the user can receive information stored at the home network node, directly and/or via the host server.

Various approaches for delivering data to the remote network access appliance are implemented in connection with different applications, depending upon the conditions surrounding each application and other relevant concerns. In each application, the host server controls the routing of data from the home network node (and other home network nodes). In one delivery example, software at the home network node is configured to make the data available to the host server, with the host server retrieving the data from the home network node and passing the retrieved data to the remote network access appliance. In another delivery example, software at the home network node makes data available directly to the remote network access appliance using, for example, an internet interface provided by the host server.

Access to data at each home network node is controlled by the host server using an authorization criterion to limit access to the home network node. Where user-specific criteria, such as identification (e.g., user name) and security code (e.g., a password) are used, this information may be stored at a remote network access appliance and automatically provided to the host server, at the host server (or elsewhere on the network) or input by a user at the remote network access appliance. In some applications, identification characteristics specific to each remote network access appliance is used as authorization criterion, with such identification information provided by the remote network access appliances to the host server. For instance, where the remote network access appliance includes a mobile telephone, the telephone number may be used to grant access to data at the home network node. Other identifiers can also be used to grant access, such as a user identification number of a mobile phone or the identification of a network access appliance. In other applications, a combination of identification information specific to a remote network access appliance (e.g., a telephone number) and user-specific criteria, such as a password and/or identification, are used in controlling access to data at the home network node.

In some applications, the authorization criterion is implemented to grant specific access to limited portions of data available at the home network node. Characteristics of the remote network access appliance (e.g., its available capabilities) may also be used in connection with authorization criterion for granting access to the data. For example, where a home user grants access to data at the home network node to a remote user, the home user may wish to limit the remote user's access to select data. In this regard, authorization is provided for the remote user (e.g., as associated with the remote user's identification and password) to limited portions of data available to the home network node. This approach can be implemented, for example, where a home user wishes to share selected pictures with a particular remote user; the home user configures software at the home node and/or at the host server to grant access to these selected pictures (e.g., by referencing the pictures or placing them in a particular directory). With the granted access, the remote user can access and view the selected pictures via a remote network access appliance.

In another embodiment, the host server and/or software implemented at a home network node facilitates the protection of rights associated with data stored at the home network. These rights, such as those rights often referred to as digital rights management (DRM), are often associated with copyright or other laws regulating the use and/or distribution of data. In some instances, rights are simply associated with a desire to protect personal and/or confidential information. In this regard, one or both of the host server and software implemented on the home network node implements approaches relative to the protection of these rights.

One example application involving the protection of data relates to the distribution of music. Where music is protected, the host server and/or home network node can be programmed with distribution control programming that ensures that delivery of the music via the network is usable by the remote network access appliance and, in some instances, protected. In some applications, the music is delivered to the remote network access appliance in an original protected format, such as that in which music is delivered (upon purchase) via the internet. In applications where the remote network access appliance is unable to use the data in the original protected format, the host server and/or the home network node may remove the original protection and send the data in an unprotected format. In other applications, original protection is removed and data is re-protected using a protection scheme usable by the remote network access appliance; this approach is useful, for example, where protected delivery is desirable but wherein delivery in an original protected format is not. In this regard, a user storing music on his or her home network node (e.g., a PC) can access the music via a remote network appliance (e.g., a mobile telephone) while maintaining assurance that the music is properly distributed in view of media rights and/or characteristics of the remote network access appliance.

In some applications, the delivery of data such as media content involves configuration of the content into a format that is amenable to delivery to and/or use at the remote network access appliance. For example, where a remote network access appliance is capable of displaying pictures in a particular format, pictures requested by the remote network access appliance are formatted so that the remote network access appliance can display the pictures. In addition, where data transfer rate is limited by available connections (bandwidth), pictures may be formatted so that each picture requires a relatively lesser amount of data (e.g., high resolution images are formatted to a lower resolution to reduce image data size, prior to transfer). As another example, when audio data such as music is requested and the remote network access appliance is adapted for playing audio data in a particular digital audio format (e.g., mp3 format), requested audio data is formatted into the particular digital audio format.

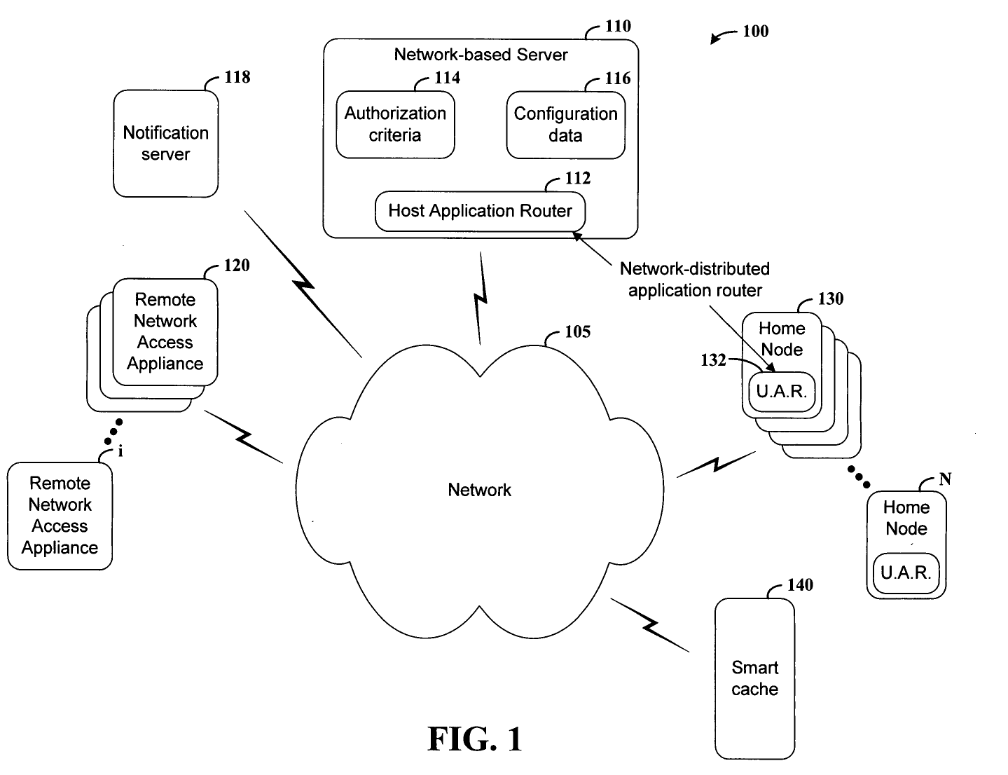

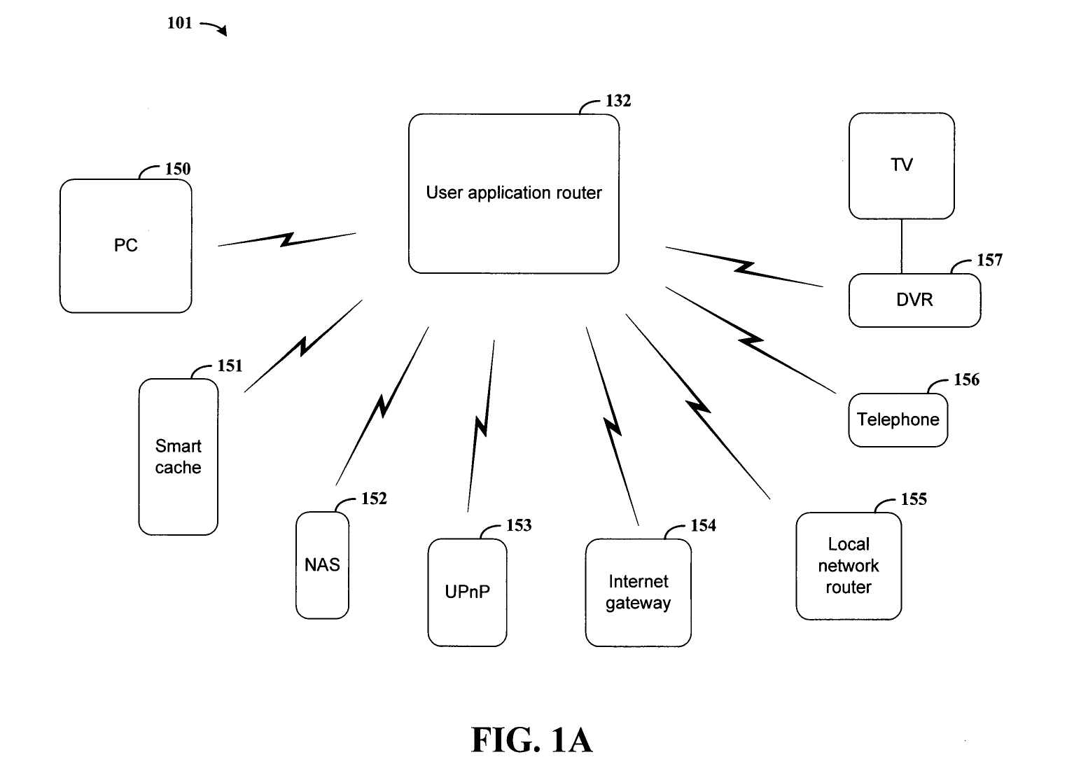

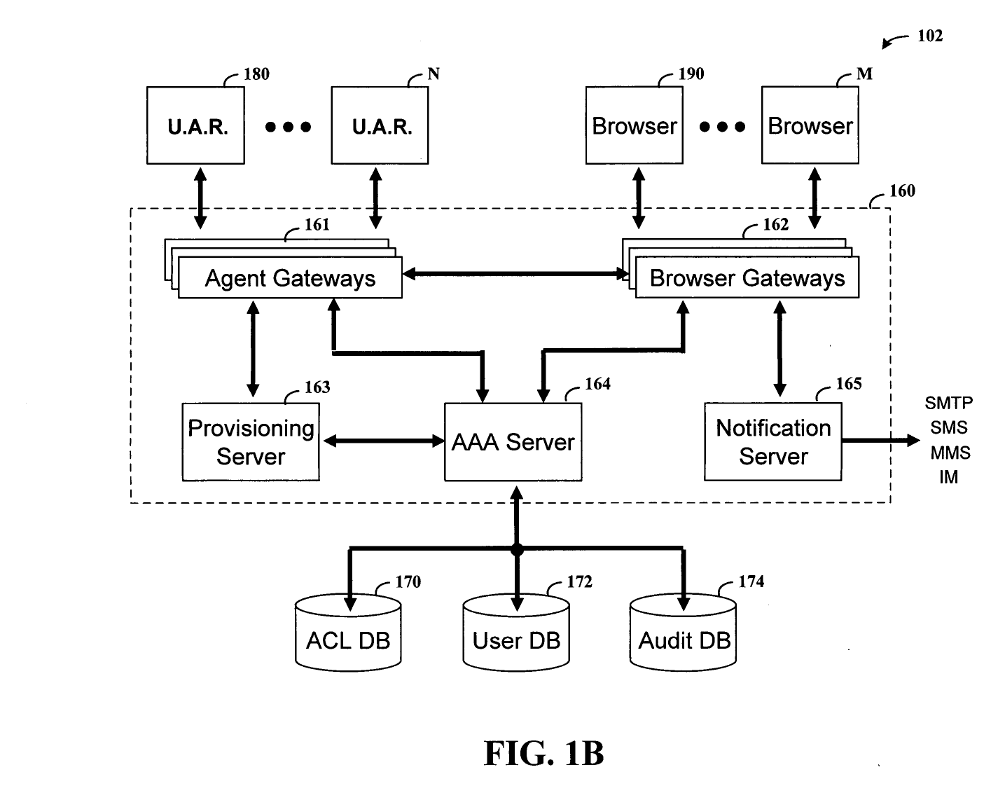

FIG. 1 is a system 100 for routing data via an internet protocol network using a server-hosted interface, according to another example embodiment of the present invention. The system 100 includes a network-based server 110 that hosts the interface, a plurality of remote network access appliances 120-i and a plurality of home nodes 130-N, all of which communicate via a network 105. The network 105 includes an internet protocol-based network such as the Internet and, where appropriate, one or more other networks such as a mobile telephone network or a local area network (LAN). In some applications, the network 105 is a local area network implemented for a locality such as a home or business. In other applications, the network 105 is or includes a virtual network or set of virtual application communication channels within a processor or group of processors associated with a computing appliance.

The network-based server 110 includes a host application router 112 that interacts with user application routers at each home node and hosts the interface, e.g., as an Internet web page. In this regard, each home node includes such a user application router, with home node 130 shown including a user application router 132. The user and host application routers work together to make up a network-distributed router, the host application router 112 operating personal network-distributed routers for each user, such that each user's personal router (e.g., each user's personal network) includes that user's application(s) at the user's home node(s) operating together with the host application router 112. In some applications, the user application router 132 is configured at the network-based server 110 and downloaded to home nodes as a software download, and implemented on an appliance such as a personal computer or a network router. Each user can thus access his/her data at the user's home node or nodes, using his/her personal router and data at the user's home node(s).

Using the interface, the network-based server 110 selectively facilitates user access to data at one or more of the home nodes 130-N, via one of the remote network access appliances 120-i. The network-based server 110 implements authorization criteria 114 for authenticating a particular user in response to a request for access to data via one of the home nodes 130-N or one of the remote network access appliances 120-i. In this regard, when a user at a remote network access appliance requests data such as image, audio and/or video media content from a particular home node, the network-based server 110 processes an authorization for the request by the user using the authorization criteria 114. If the authorization is successful (e.g., authorization criteria are met), the network-based server 110 facilitates the communication of data from one or more of the home nodes 130-N to one of the remote network access appliances 120-i to which the user requested data.

The network-based server 110 also stores and uses configuration data 116 that includes a variety of configuration information used by the host application router 112 to facilitate the transfer of data on behalf of a user. The configuration data 116 is generally provided by users and further augmented by the network-based server 110 to include information useful in processing information on behalf of each user. The configuration data 116 may also include information from one or more service providers associated with users of the system, with the configuration data including, for example, global and/or specific policies related to each user's system use.

The configuration data 116 typically includes user preferences relating to a variety of user-specific functions, such as the type of interface presented to each user, the manner in which to present and/or deliver available content, accessibility limitations (e.g., to associated users) and data transfer characteristics. For instance, where a user prefers the delivery of a particular format of data to his/her remote network access appliance, that user may specify the format in user preferences; the host application router 112 works to format the data appropriately before sending the data to the user's remote network access appliance. This formatting may involve implementing the user application router at the user's home node for formatting the data and/or formatting the data at the network-based server 110.

The configuration data 116 further includes information used by the network-based server 110 to communicate with and/or access each user's home node, such as the home node's address relative to the network 105 (e.g., each user's IP address and/or name space address) and security information. Where a user has more than one home node, such as with a household “user” having different computers used by different household members, or wherein different “home” nodes are located at different places on a network, the configuration data 116 reflects these multiple home nodes. User access with multiple home nodes in a household typically involves the network-based server providing an interface for, and access to, multiple computers to individuals associated with the household or business (and having the corresponding authorization). User access with multiple home nodes across a network wherein, for example, a user has different home node locations such as different places of residence and/or business, similarly involves the provision of access to multiple computers at different locations on a network, with a portion of a routing controller implemented at each location.

One particular user access approach involving multiple “home” nodes involves user access to multiple network-based home nodes from which the user is authorized to access data. For example, where a user at the remote network access appliance 120 purchases data such as a movie, music or software, a content provider having multiple home source nodes at which the data or media is located can grant the user access to these multiple nodes for downloading the purchased data. In this regard, a user can download data for a single purchase from multiple sources, thus speeding up the delivery of data. This approach may also involve the use of different home nodes implemented by users subscribing to a particular service, with each user making data available at his or her home node for subsequent transfer to an end user at a remote network access appliance. In these instances, the host application router 112 works with user application routers at each involved home node to manage the data transfer.

In some applications, the network-based server 110 grants access to information at multiple home nodes to a particular user, based upon the above-discussed authorization. For example, users may have more than one home node, such as two or more computers on a home or business network, or two or more computers on separate networks. The network-based server 110 works with user application routers at each home node to make content available the user, when the user is so authorized. Where used to show available data, the interface is configured to display data from all home nodes to which a particular user is authorized access.

Depending upon the particular application and type of data being transferred, the network-based server 110 tracks the transfer of data between the home nodes 130-N and the remote network access appliances 120-i. Where data having associated media rights (e.g., copyright) is transferred, the network-based server 110 tracks the transfer of the data to ensure that regulations associated with particular media rights are followed. For instance, where purchased music is transferred, rights associated with the music may limit the distribution of the music to users other than the purchaser. In this regard, the network-based server 110 tracks any transfer of purchased music to ensure that applicable regulations are met.

The system 100 is adapted to work in a variety of environments involving disparate networks, home node devices, remote network access appliances, data and characteristics thereof. One particular use-case scenario involves remote data access as follows. When a particular user who is party to the home node 130 (e.g., a homeowner having media content stored at his or her home computer) wishes to establish remote access, the user signs up for a service provided via the network-based server 110. The network-based server 110 prompts the user for access information to the user's home node 130 so that the host application router 112 can interact with the user's home node. This access information includes sufficient information for identifying the home node 130 on the network 105 and other appropriate information, such as data locations at the home node 130 that are accessible by the network-based server (and/or by remote network access appliances). The access information is stored with the configuration data 116, together with other information for the user as appropriate for the particular implementation.

The user application router 132 (software implemented, e.g., on the user's home computer, router or other network appliance) is installed at the user's home node 130 and is configured for operation in connection with the host application router 112. In some instances, some of the functions discussed as carried out with the host application router 112 are established and/or implemented at the user application router 132, such as the limiting of access to particular data locations at the home node 130.

An account is established for the user, with service type information (e.g., billing information) at the network-based server 110. The account includes authorization information established with the user, which is presented to the user for use in accessing the network-based server and, accordingly, his/her home node 130 as well as account information via the network-based server. This authorization information is stored with authorization criteria 114.

The user employs the remote network access appliance 120 for accessing data at the home node 130 by visiting the interface (e.g., web browser) presented by the network-based server on behalf of the user. In some applications, a user application router type function is also implemented at the remote network access appliance 120. This data access may involve, for example, the use of an Internet-capable mobile telephone as the remote network access appliance 120, with the interface being accessed as a web page via the mobile telephone. The user provides authorization information to the network-based server 110 via the interface. The authorization information may involve one or both of user-input authorization information (e.g., a password or voice for voice recognition) and identification information associated with the remote network access appliance 120. The network-based server 110 uses the authorization information together with the authorization criteria 114 to determine whether access is authorized.

Once the user has been authorized via the remote network access appliance 120, the network-based server provides the user with information regarding available data such as media content via the interface, viewed as a web page. One or both of the home node 130 and the network-based server 110 provide some of or the entire interface and a listing of available data for transfer. The listing of data may be tailored to a particular user's preferences, device capabilities, or otherwise limited in scope to restrict the data to which a particular user has access. The user selects data for transfer and the host application router 112 responds by interacting with the home application router 132 to facilitate the transfer of data to the remote network access appliance 120. This data transfer is carried out in accordance with the user's selection and the configuration data 116.

Where the selected data requires formatting, such as where the user's remote network access appliance 120 desirably receives data in a particular format, the host and user application routers 112 and 132 work to format the data. For instance, where data is music and wherein the remote network access appliance 120 desirably plays music in a first format but the music is stored at the home node 130 in a second format, the music data is formatted into the first format prior to transfer to the remote network access appliance. The formatting is generally carried out at one or both of the home node 130 and the network-based server 110, depending upon the particular application. In some applications, the user application router 132 formats the data, prior to transfer to the remote network access appliance 120. The data is then transferred from the home node 130 to the remote network access appliance 120, via the network-based server 110 and/or directly via the network 105.

The type of format in which data is desirably received at a particular remote network access appliance is set in one or more of a variety of manners. In one application, the configuration data 116 includes information regarding the format of data for a particular network access appliance; when a user requests data for that particular appliance, the network-based server 110 works with the home node to set the data in the format indicated in the configuration data. In another application, users manually select a data format when requesting data via a remote network access appliance. In other applications, the data format is automatically selected by one or both of the network-based server 110 and the home node to which access is requested, using information identifying the type of network access appliance to which the data is to be transferred (e.g., as included in the request communication therefrom).

Referring again to the above use-case scenario, another data transfer approach involves the delivery of streaming data to the remote network access appliance 120 via the network-based server 110. Streaming data may involve, for example, the passage of data from a streaming data appliance, such as a television tuner, a video camera or a radio receiver, or the streaming of data from a network-based streaming source, such as an Internet radio station or other live broadcast source, or from a network-based video source. This streaming of data may also involve the application of subscription services or other fee-based use authorization that is implemented in connection with the data transfer and is applicable, for example, on a user-specific basis.

The host and user application routers 112 and 132 work to configure the streaming data in a proper format and, further, to transfer the data at a desirable transfer rate, relative to available bandwidth. The transfer rate may, for example, be relative to the condition of the network 105 and may further be characterized by transfer-related characteristics such as quality of network connection and associated functions, such as buffer size and approach. Further, the format is optionally carried out as a condition of the network 105 and/or the remote network access appliance 120, as relative to available transfer rate. For instance, where a user requests streaming music from the home node 130, the available transfer rate is used to select the format of the music. Where available transfer rate is low such as with a mobile telephone network, lower bit rate data is used to reduce the amount of data required to be transferred for the selected music (and, accordingly, also resulting in relatively lower quality audio). Where available transfer rate is high, such as with a high-speed Internet link such as a DSL link, high bit rate data is used, facilitating high-quality music listening.

In some streaming applications, streaming data is protected or otherwise controlled using one or more of a variety of approaches to comply, e.g., with rights associated with the data or other applicable rights, such as those implemented by government agencies in association with the delivery of data. For example, where streaming media is protected by media rights, the application router uses protection to ensure that the transfer adheres to associated media rights. A variety of protection approaches, such as those discussed below, are implemented in accordance with the particular application and data use characteristics of the particular remote access appliance that will be using the data.

Where streaming data is subject to government type rules, such as those associated with the rebroadcast of a television or radio broadcast or rules, the application router transfers the data (or prevents the transfer of data) in connection with the rules. For instance, where the rebroadcast of a television broadcast is not permitted, the application router transfers data to ensure that any user receiving the broadcast is doing so without introducing issues relating to the rebroadcast such as by ensuring that an end user receiving the broadcast is entitled to do so as an original broadcast. Such rebroadcast may be facilitated in accordance with, e.g., conventional transfer of broadcast data to a remote television in one's own home.

In some applications involving the transfer of streaming data such as television data, the application router ensures compliance with blackout rules associated with a location in which the remote network access appliance exists. For example, where the broadcast of a particular streaming television signal is subject to blackout rules, such that the signal is not to be broadcast in a certain geographical region, the application router determines the location of the remote network access appliance before facilitating the transfer of the streaming data. Where the location of the remote network access appliance is in compliance with blackout rules, the application router enables the transfer of streaming data, and where the location is not in compliance with blackout rules, the application router disables the transfer of streaming data.

In one application involving a mobile telephone as a remote network access appliance, the application router identifies the location of the mobile telephone before enabling the transfer of data such as streaming data subject to blackout rules or other localization information. This identification may be facilitated using, for example, the identification of a local transmission location (e.g., a transmission tower or GPS) via which the mobile telephone communicates. When the location of the mobile telephone is determined, that location is used to determine whether the transfer of streaming data is appropriate, and the transfer is carried out (or not carried out) appropriately.

In another example embodiment, the network-based server 110 facilitates the transfer of data from one of the remote network access appliances 120-i to one of the home nodes 130-N, using an authorization approach similar to that discussed above. For example, when a user at the remote network access appliance 120 wishes to send an image to his/her home node 130, that user accesses the interface provided via the network-based server 110. Once authorized, the user uploads the image to the home node 130, which responds by accepting the image and storing the image locally. With this approach, image storage is facilitated with the remote network access appliance 120 while utilizing the data storage capabilities of the home node 130. When implemented with a camera device, the remote network access appliance 120 enjoys a large quantity of storage space for pictures relative, e.g., to conventional cameras (and camera phones) where space is limited to storage at the camera. Further, when images are uploaded to the home node 130, adverse conditions such as lost or stolen cameras or camera phones do not necessarily suffer an associated loss of image data, relative to conventional approaches where images are stored at the camera or camera phone.

Some applications involving the selective transfer of data use a token or other deliverable authentication data to authenticate or otherwise enable a user to access and, where appropriate, use data. The token generally includes authorization information that is sent to a user at a remote network access appliance. For example, an electronic token may include a link to a particular web page hosted by the network-based server 110, with security type information embedded in the token for use in granting access to data stored at a home node. In addition, the token may also include information that can be used to link an end user with data, such as an identification of a storage location for the data.

The token is generated using one or both of the host application router 112 and a user application router (e.g., 132) at the home node from which data is transferred. In some applications, a user accessing his or her home node via a remote network access appliance causes the home node and/or the host application router 112 to generate the token. A home node user then sends the token, such as via email, to an end user at a remote network access appliance. In some applications, the home node and end users may be the same person, for example where a particular user wishes to access his or her own data at a home node, when using a remote network access appliance.

A user at a remote network access appliance receiving such a token uses the token in one or more of a variety of ways to communicate with the network-based server 110 and ultimately to facilitate the transfer of data from a particular home node to which the token applies. In some applications, the end user implements the token directly, e.g., by clicking on a link associated with the token as sent in an electronic communication such as an email or instant message, or otherwise sending information associated with the token to the network-based server 110. Certain applications also require an end user to supply a password or other security criteria when implementing the token.

In some contexts, the token is implemented with a transmission report. That is, where a particular user at a remote network access appliance receives a token, that user sends a transmission report (e.g., by clicking on a link provided with the token) that is sent back to the network router. The network router (implemented at one or both of the host application router 112 and the user application router 132) in turn sends authentication and/or security information to the user at the remote network access appliance to make transferred data usable thereat. This approach may be implemented, for example, where the token includes a link to the data, where the token includes the data or where the token is delivered along with the data.

Certain implementations involve the use of tokens having a lifetime, with the tokens usable more than once. For instance, where a token provides access to a particular media file or files, a user holding the token at his or her network access appliance can access the particular media file or files throughout the lifetime of the token. In addition, when updates are made to the media file or files to which the token applies, notification can be sent to a user holding the token. For example, where a token grants access to a file including a personal digital photo album shared by multiple family members, each having token access, updates to the photo album can be announced to the family members.

Another example embodiment is directed to the use of a token for promotional purposes, where user reaction to the token is tracked and used for promotions. For example, a token may include information enabling a user at a mobile telephone to access and download a ring tone that is a short music clip. If the user likes the ring tone and subsequently purchases music relating to the clip (or otherwise), information in the token is used to track that purchase. In some applications, a royalty (e.g., funds, service or other item of value) is given relative to the tracked purchase. The royalty may be facilitated, for example, by tracking the source of the token and giving that source a royalty based upon the purchase.

In another implementation, the network-based server 110 is configured for processing requests for data transfer in accordance with media rights associated with the data. Media (or other data) rights are often the subject of rules, regulations, contracts or other agreements relating to the rights associated with the data. In this regard, these rules, regulations, contracts or other agreements are implemented to ensure that any transfer of the data complies with these agreements. For instance, as discussed above, certain data such as media is protected by copyright or other digital rights management (DRM) protection. Where the transfer of the protected data needs to comply with particular rules or regulations, the network-based server 110 and corresponding home node are configured, via the host application router 112 and the user application router at the corresponding home node, to take steps to ensure the transfer of data is in compliance.

For example, where a user at the remote network access appliance 120 requests the delivery of protected data, the host application router 112 works with the user application router 132 to process and transfer the requested data accordingly. In some applications, this transfer involves simply passing protected data to the remote network access appliance 120, which processes the data with protection for use. In applications where the remote network access appliance 120 cannot process data in a particular protected format or where the passage of protected data is undesirable, the application router configures the data into a protected or unprotected format that can be used by the remote network access appliance.

In some applications, the network-based server 110 blocks access to certain files relative to the type of file and applicable regulations regarding the transfer of the type of file. For example, access to protected media may be blocked to any user other than a user verified as being the owner of the protected media, e.g., where a user at home node 130 makes data available to his or her personal remote network access appliance 120.

In certain implementations, the network-based server 110 tracks the transfer of protected data and, where appropriate, reports irregularities or potential abuses. For instance, where a password for controlling user-specific access to protected media is used by more than one user at a time, or used at a relatively high frequency, the network-based server 110 can detect these uses and flag the use as potentially in violation of relevant media rights. Such an approach addresses the potential of users illegally sharing their information with others. Relative to the token approach discussed above, the frequency and timing of token use and/or an identification of appliances using the tokens, can be similarly tracked and used to identify any irregularities. In some implementations, a user's account is automatically shut down, effectively stopping any transfer of data, upon detection of a potential irregularity.

Data (e.g., media) rights are protected in a variety of manners. In some implementations, encryption, password protection or forward-blocking approaches (i.e., preventing received data from being re-forwarded) are used to ensure that protected content is transferred in compliance with applicable rules. These approaches may be implemented in connection with the original protection applied to data or with re-protection, where the application router removes the original protection and re-protects the data for delivery to a remote network access appliance.

For certain applications requiring the delivery of data in accordance with particular protection approaches, such as those implemented with relevant communication rules and/or laws, the host and user application routers 112 and 132 use some or all of these approaches to ensure compliance. In some applications, the application router removes the original protection from data and sends the data in an unprotected format to a remote user, where such unprotected delivery is acceptable (e.g., where delivery to a particular user's remote network access appliance is in compliance with applicable rules). In other applications, the application router re-protects the data in a manner such that the data can be processed by the remote network access appliance. Still other applications involve the use of a token as discussed above, with the token including, for example, authorization for a particular user to receive and use data, or application software that facilitates the use of protected data at a remote network access appliance.

In another example embodiment, the application router implemented with the host application router 112 and a user application router (e.g., 132) is configured to select a particular communications medium in the network 105 to use in sending data to a remote network access appliance. For example, certain remote network access appliances are capable of connecting to different networks (e.g., implemented as represented by the network 105). Mobile telephones are one example type of remote network access appliance that can be used in connection with such an approach, where a particular telephone may be capable of receiving data over different communications links (e.g., via a GSM (global system for mobile communications) link, a CDMA (code division multiple access) link or a local wireless internet link). In this regard, where multiple networks are available and where a particular network access appliance to which data is to be transferred is capable of receiving information via the multiple networks, the application router selects one of the networks via which to send data.

One application involving the above-mentioned approach to communications medium selection involves the use of a mobile telephone or other device configured to communicate via both a mobile telephone network such as a GSM network and a local wireless internet link (e.g., commonly referred to as “wi-fi”). Where a mobile telephone network is available (as typically readily available for telephony communications), telephone and/or data communications can be sent via the mobile telephone network. Where a wireless internet network link is available, data communications can be selectively sent via the wireless internet network link, generally facilitating higher data transfer rates than mobile telephone links and, in many instances, relatively more economical data transfer. The wireless internet link is also used for telephony communications, e.g., where the mobile telephone is configured for internet protocol (IP) telephony type communications.

The combination wireless internet/mobile telephone capable phone can be used in a multitude of manners, depending upon the particular application, available networks, user configuration and service provider conditions. For instance, when such a mobile telephone is used in an area offering no wireless internet link, or where any wireless internet link is not robustly available, the mobile telephone network is used for data and voice communications. Conditions relating wireless internet availability may be detected, for example, by the telephone itself or by the network-based server 110, e.g., by using information associated with an identified mobile telephone communications source such as a transmission tower. When the mobile telephone has access to a wireless internet link, the link is used for communicating data and, in particular, for communicating data having a relatively large size (and thus benefiting from high bandwidth communications and potential lower cost communications channels). Such wireless links are typically available, for example, in airports, coffee shops, educational institutions or other locations where a wireless internet link is desirable; furthermore, as wireless internet technology grows, these links are becoming more widespread and are implemented publicly in a variety of regional locations.

In some applications, configuration settings in the mobile telephone, at the network-distributed application router or at other nodes in the system 100 are set to control the delivery of data to the mobile telephone as a function of the availability of a wireless network. For example, where a user requests data such as a movie or a presentation having a relatively large data file size, settings at one or more locations in the system 100 may be configured to transfer the data when a wireless internet link is available to the mobile telephone. In this regard, user configuration may be implemented to make wireless internet transfer a desirable option for data files over a certain size, with an option to override the settings to effect transfer over a mobile telephone network. This approach may be useful, for example, where immediate data transfer is not necessary or where a user elects to wait to transfer data until a wireless internet link becomes available for economic or other reasons. In this regard, a user can request a particular set of data and the network-distributed application router (112 and/or 132) can be implemented to automatically transfer the requested data when a wireless internet link becomes available to the mobile telephone or when a user specifically initiates the transfer.

Another example embodiment relative to the use/selection of wireless internet networks and a mobile telephone network involves the transfer of data from a remote network access appliance (e.g., remote network access appliance 120 to home node 130 in FIG. 1). The transfer of data in this direction may be managed in a manner that is similar to the management of data transfer from the home node to a remote network access appliance. For example, where a video or picture(s) is taken with a mobile telephone, the file size associated with that video or picture(s) may be large. In this regard, the information can be selectively transferred to the home node relative to the availability of a wireless network. One such application involves the use of a camera phone; when a user has taken several pictures, those pictures can be uploaded to his or her home node when a wireless network is available. With this application, photos taken can be securely stored at a home node while freeing up space at the camera phone for taking additional pictures. Many other applications (e.g., video) are implemented in a similar manner.

Referring again to FIG. 1, the selection of a particular network over which to send data may involve the consideration of one or more of a variety of network characteristics, such as transfer rate, reliability, availability, rights protection, cost and others including, for example, those discussed above. Users employing the network-based server 110 for the transfer of data may also provide user-specific data regarding preferences for data transfer in the realm of multiple available types of networks. The preferences may be provided in the form of configuration data 1116 that the application router can access and use in selecting a particular data transfer network or time, or may involve a selection by a user at a remote network access appliance made in connection with a particular data transfer event. These user preferences or selections may involve the direct selection of a particular network or, for example, the selection of criteria for use by the network router in selecting a network on behalf of a user. In this regard, the application router employs criteria in selecting a particular network via which to send data and, in some applications, in selecting a particular time during which to send the data.

In another example embodiment of the present invention, a smart cache 140 is implemented with the system 100 for storing (caching) data to be transferred over the network 105 to one or more of the remote network access appliances 120-i. The smart cache 140 is configured for storing data and accordingly involves devices such as a database system or other data storage arrangement accessible by the network-based server 110. The smart cache 140, while shown as a separate arrangement, can be selectively implemented with one or more of the devices/networks shown in the system 100, such as with the home node 130, the network 105, the network-based server 110 (or a different network-based server) or a remote network access appliance 120.

When data is transferred between one or more of the home nodes 130-N and one or more of the remote network access appliances 120-i, the smart cache 140 can be implemented as a buffer and/or storage arrangement. For example, when a user at home node 130 wishes to make selected audio data (e.g., certain music) available to his or her mobile telephone or other remote network access appliance, that user can initiate data transfer, using the host application router 112 together with the user application router 132 to the smart cache 140. This data is then available for subsequent download and/or streaming to the user's remote device. In a reverse transfer application, data can be transferred from a remote network access appliance to the smart cache 140, irregardless of availability of a particular home node to which the data is sent. Subsequently, the home node can access the smart cache 140 to retrieve the data. With these approaches, a home node or remote network access appliance need not necessarily be accessible to facilitate a transfer of data. Furthermore, where transfer of data involves the transfer of streaming data, the smart cache 140 can be implemented as a buffer to accommodate potential problems with communicating over one or more links in the network 105, or simply to pause the stream of data (e.g., to pause video and/or audio playback).

Another application of the smart cache 140 involves the cache implemented at a home node, such as in a personal computer or with a storage device at the home node 130. Generally, where a user application router 132 is active and the cache is active (or can be activated by the user application router 132), access to the cache is available to a remote network access appliance. In this regard, a user at an appliance such as a personal computer can transfer data to the smart cache 140. Once transferred, the personal computer or other appliance can be shut down while ensuring that the data is available in the cache for access. For example, where a network attached storage (NAS) device is implemented at the home node 130, a user at a PC at the home node can designate a particular file in the NAS to be available for data transfer. The NAS (or a file therein) acts together with the user application router 132 as the smart cache 140; access and data transfer are effected in a manner similar to those discussed herein.

In some applications, the user application router 132 administers the storage of data in the smart cache 140 using conditions relative to the particular type of data transfer scenario in which the smart cache 140 is implemented. Where use of the smart cache 140 is appropriate or otherwise beneficial, the user application router 132, possibly in connection with the host application router 112, facilitates that use by automatically managing transfer to and from the smart cache. In other applications, a user at a home node or remote network access appliance manually directs the storage and/or retrieval of data at the smart cache 140, such as by physically storing information at a local or remote data storage (cache) location. Depending upon user selections, certain data may be stored in the smart cache 140 based on a rule implemented with the user application router 132, such as for data a particular user needs to access on a regular basis or for data requiring a long time for transfer, such as video data.

In some applications, the network-distributed application router accesses the smart cache 140 using a protocol-based approach for retrieving data. For example, where a user at the remote network access appliance 120 requests data made available via the home node 130, the network-distributed application router ascertains whether the requested data is available in the smart cache 140. If the data is available at the smart cache 140, the data is transferred to the remote network access appliance 120. If the data is not available at the smart cache 140, the network-distributed application routing controller accesses the home node 130 to retrieve the data.

When data is undergoing transfer to the smart cache 140, one or both of the user application router 132 and the host application router 112 monitor the data transfer and, where appropriate, communicates with the device making the transfer to ensure that the transfer is effected properly. For example, where a user elects to transfer data from his or her PC to the smart cache 140, the transfer is monitored to ensure that it is successful. For instance, if a user attempts to shut down his or her PC or otherwise interrupt the transfer, a warning communication (e.g., a pop-up message on a PC monitor) is generated to alert the user that the transfer has not been completed.

In another embodiment involving the smart cache 140, video is streamed to a remote network access appliance using the smart cache to store some or all of the video as a buffer. For example, where a user orders a movie, via a home node 130, to be downloaded for playback at a remote network access appliance 120, a selected amount of the video data for the movie can be stored at the smart cache 140. Once playback is started, data sent for playback is deleted from the cache 140 or otherwise made inaccessible, with remaining data for the movie being sent to the cache 140 or, in some instances, directly to the remote network access appliance 120. In some applications, the movie data stored at the smart cache 140 is unusable at the remote network access appliance (or any appliance) until an enabling stream of data, such as that involving encryption information or video data, is sent to the remote network access appliance. This enabling stream of data is used to make the movie data available at the remote network access appliance. With these approaches, movie data is transferred, with at least a portion of the movie data stored in the smart cache 140, while maintaining relevant media rights to the movie in that a usable copy of the movie is not necessarily stored at any location.

Other applications are directed to a token approach, similar to that discussed above, using the smart cache 140 to store information to which a token is directed. For example, where a user at a home node sends a token for use at a remote network access appliance for retrieving a particular set of data, the particular set of data can be stored in the smart cache 140. The token may, for example, point to the section of the smart cache 140 in which the data is stored. When a user at a remote network access appliance implements the token, the particular set of data at the smart cache is sent to the remote network access appliance.

The home node 130 and user application router 132 are implemented in a variety of manners, depending upon the application. In some applications, the user application router 132 is located at a home computing device such as a desktop or laptop computer. In other applications, the user application router 132 is programmed into a router, modem, data storage device or other user device implemented in a home, office or other (generally local) network system. Furthermore, the user application router 132 can be implemented with one of the remote network access appliances 120-i in certain applications. In this regard, FIG. 1A shows different example embodiments involving a user application router.

FIG. 1A shows a home network configuration 101 involving the user application router device 132, according to another example embodiment of the present invention. As discussed above, this configuration 101 may be implemented in connection with one or more of the home nodes 130 as described with FIG. 1, with some or all of the devices shown in FIG. 1A making up such a home node. The user application router 132 is shown as a separate device but may be implemented in connection with one or more of a variety of devices, including those shown. Shown by way of example are a personal computer 150, smart cache 151, network attached storage (NAS) device 152, universal plug and play (UPnP) device 153, internet gateway 154, local network router 155, telephone 156 (e.g., an IP telephone) and/or digital video recorder (DVR) 157 (or, e.g., a personal video recorder (PVR). Some or all of these devices are connected on a home (or business) network with the user application router 132 controlling access to one or more thereof for file transfer or streaming data transfer with a remote network access appliance. Furthermore, the shown devices may communicate with one another, directly or via a router (e.g., the local network router 155), for transferring data and/or implementation user application router functions.

In one implementation, the user application router 132 is integrated with the local network router 155, with functions of the user application router programmed into the local network router. In this regard, the individual devices shown in FIG. 1A need not necessarily be powered to facilitate data transfer with the home node represented in the configuration 101. For instance, where data stored on the NAS device 152 is desirably made available to the remote network access appliance 120 (of FIG. 1), the local network router 155 can directly control access thereto without necessarily involving the PC 150 (or other controlling device). Furthermore, where appropriate, the local network router 155 can be programmed, together with one or more of the devices shown, to power the device (e.g., wake the device from a low power sleep mode to an active awake mode) to facilitate data transfer therewith. These and other approaches are readily implemented with the user application router 132, whether integrated with the local network router 155 or with another device.

FIG. 1B shows an implementation of a network-based server arrangement 102, according to another example embodiment of the present invention. A network-based server 160 communicates with users via agent 161 and browser 162 gateways, and further communicates with databases 170-174 to implement various server functions. The network-based server 160 can be implemented, for example, with the network-based server 110 shown in FIG. 1.

The agent gateways 161 communicate with a plurality of user application routers 180-N implemented, for example, with home nodes 130-N as shown in FIG. 1. The browser gateways 162 communicate with a plurality of browsers 190-M accessed, for example, with the remote network access appliances 120-i as shown in FIG. 1. For example, a user implementing a laptop or a PDA as a remote network access appliance can access the browser 190 to interface with the network-based server 160 and, ultimately, to retrieve data accessible at home nodes at which one or more of the user application routers 180-N are implemented. In some applications, the browser functions shown with browsers 190-M are implemented with a client, such as that involving software stored at a remote network access appliance, either accessing a web page or otherwise communicating via gateways 162. The client may be downloaded, for example, by a remote network access appliance first accessing a browser (e.g., 190), and subsequently downloading the client.

A provisioning server 163 provides software used at the user application routers 180-N for routing data. An authentication, access and accounting server 164 facilitates the establishment of user accounts, with data relating to the accounts stored in the databases 170, 172 and 174 respectively for an access control list (ACL), user data and auditing data (e.g., for accounting purposes). After the user application routers 180-N have been programmed with provided software, and using the information stored at these databases, the AAA server processes data transfer between a home node at one of the user application routers and a remote access appliance via one of the browsers 190-N.

A notification server is optionally implemented with the network-based server 160 as discussed, for example, with FIG. 1. The notification server communicates with users using one or more of a variety of communications, such as those involving SMTP (email), SMS (short message service), MMS (multimedia messaging service) or IM (instant message) messaging approaches. This notification may be implemented, for example, to provide tokens, passwords, alerts or other information to users involved (or invited to be involved) in data transfer via the network-based server arrangement 102.

In some applications, the network-based server 160 is configured to learn user preferences by tracking user data selections made via remote network access appliances and/or home nodes. Data regarding these preferences is stored in the user database 172, and is used in creating an interface for that user, either at one of the user application routers 180-N or via a browser/client interface 190-M.

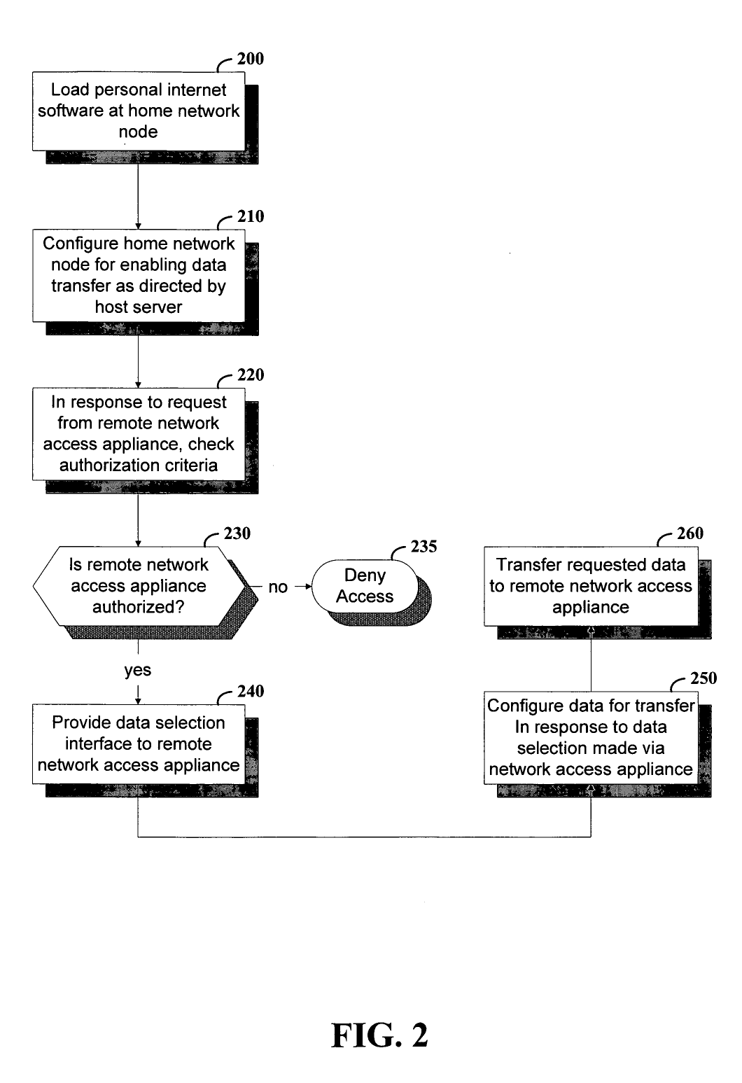

FIG. 2 is a flow diagram showing an approach to the communication of data for peer-to-peer routing involving the establishment and operation of personal-based internet networks for individual user groups, according to another example embodiment of the present invention. At block 200, personal internet software is loaded at a home network node, such as on a user's home personal computer (PC) or server, or at a router having the personal internet software preloaded (e.g., at a manufacturer or retailer). Such a home network node may be implemented, for example, in a manner similar to the home network node 130 in the system 100 shown in FIG. 1. Where the home network node includes more than one location at which data is stored, such as where multiple computers and/or other network storage devices are coupled to a LAN, the software is loaded in a manner that facilitates access to data on each of these data storage locations to which remote access is desired.

At block 210, the personal internet software implementation at the home network node is configured for establishing data transfer as directed by a host server. This configuration generally involves the selection of data transfer characteristics and conditions, such a those relating to authorization, data storage locations, data format, transfer rate and rights management. Once configured, the home network node is ready to grant access to data by remote network access appliances as facilitated by the network-based server.

When a request for data is received from a remote network access appliance at block 220, the network-based server responds by checking authorization criteria associated with the request. Authorization criteria in this context include, for example, one or more of a user name, a password or network access appliance identification (ID). The criteria may be stored at any location accessible by the network-based server, such as at the network-based server or at the home network node (where access to the network-based server has been granted via the configuration at block 210).

If the remote network access appliance requesting data is determined to be unauthorized at block 230, access is denied at block 235 (with appropriate action taken, such as a reply message sent to the remote network access appliance indicating the denial).

If the remote network access appliance is authorized at block 230, the host server provides a data selection interface to the remote network access appliance at block 240. This interface generally facilitates convenient access and management for data transfer functions to a user at the remote network access appliance. In this regard, a user selects, via the interface, certain data for transfer, with the selected data being configured at block 250 in response to the selection. This configuration may, for example, involve one or more of the approaches discussed herein, such as format configuration, bit rate configuration and/or media rights configuration. In some applications, data is transferred as stored and manipulation of the stored data is unnecessary such that configuration typically involves selecting the data for transfer and, where appropriate, associating information with the data to facilitate the transfer.

Once the data is configured at block 250, it is transferred at block 260 to the remote network access appliance. In some applications, the data is transferred directly from the home network node to the remote network access appliance via network communications links, such as the internet and wireless telephony links. Where direct data transfer is implemented, email can be used to facilitate the transfer, with the data connected with the email as an attachment. In other applications, the data is passed via the host server and/or a server operated by the host server.

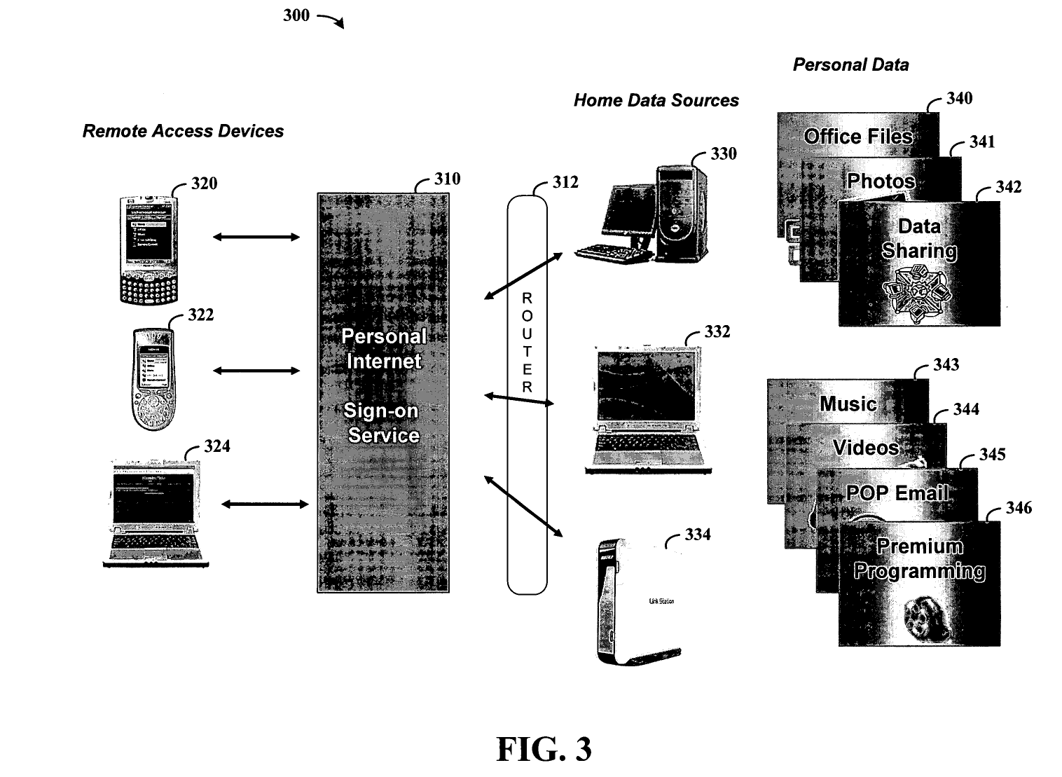

FIG. 3 is a system 300 for routing content between a user's home network machine and the user's remote network access appliance, according to another example embodiment of the present invention. This system includes a personal internet service 310 (similar, e.g., to the system shown in FIG. 1B) that facilitates the transfer of data between home data sources and remote network access appliances. A router 312 is optionally implemented to facilitate contact (e.g., via the Internet) between one or more home data sources and the personal internet service 310. In other applications, access to the personal internet service 310 is effected directly via one of the home data sources. By way of example, home data sources are shown including a personal computer (PC) 330, laptop computer 332 and a network attached storage device 334. A user application router, such as user application router 132 of FIG. 1, is implemented at one or more of the router 312 and the home data sources 330, 332 and 334 for controlling a user end of a network-distributed application routing controller, with a host application routing controller portion thereof implemented with the personal internet service 310.

The home data sources are accessible by a plurality of remote access devices including a PDA 320, mobile telephone 322 and wireless laptop 324. Each of these remote access devices is configured for logging onto or otherwise communicating with the personal internet service 310 to gain access to data via the home data sources 330-334. A variety of examples of personal data are shown, including office files 340, photos 342, data sharing-type files 342, music 343, videos 344, POP email 345 and premium programming 346, such as streaming audio and/or video. This data is generally stored at a location accessible to the home data sources or, in the context of streaming applications (e.g., premium programming 346), provided to the home data sources via some sort of communications link, such as those involved with the internet, radio waves, satellite or cable television.

In some applications, one or more of the home data sources 330-334 hosts a search engine that is accessible by one of the remote access devices. For example, where a user is subscribed to a particular content source for receiving data, a remote access device can be used to search for content via one of the home data sources.

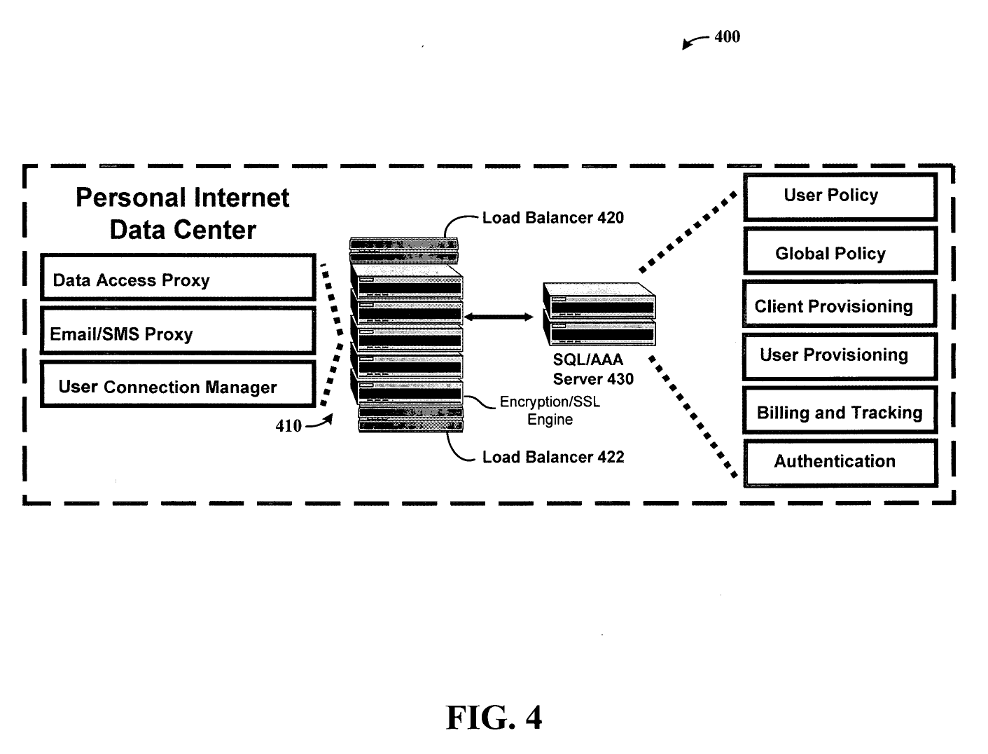

FIG. 4 shows a host server 400 configured for data routing, according to another example embodiment of the present invention. The host server 400 can be implemented, for example, in connection with one or more of the server arrangements described herein, such as with the network-based server 160 in FIG. 1B. The host server 400 provides a personal internet data center employing a data access proxy, email/SMS policy and a client collection manager implemented on one of several servers 410, with access to the servers managed using load balancers 420 and 422. This personal internet data access center implementation may be implemented, e.g., in connection with a combination of the browser and agent gateways shown in FIG. 1B. An encryption/SSL engine is implemented via at least one of the servers 410 for processing data, where appropriate. An SQL/AAA server 430 accesses rules used by the personal interned data center for establishing user access, facilitating data transfer, monitoring data transfer and other functions relative to the host server 400. In this regard, these rules may relate to one or more of user policy, global policy, client provisioning, user provisioning, billing and tracking, and authentication as shown accessible to an SQL/AAA server 430.

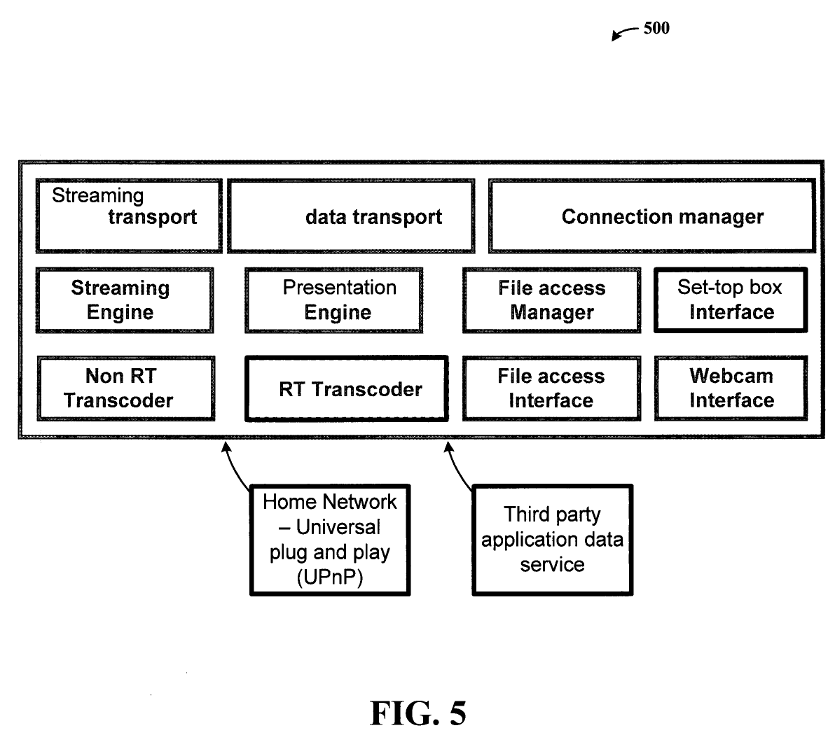

FIG. 5 shows an implementation of a home network node 500 configured for data routing, according to another example embodiment of the present invention. The home network node 500 includes a variety of functions. A connection manager establishes a secure communications tunnel with a network-based server, such as the server 110 in FIG. 1, for communicating commands and other data. A presentation engine generates a user interface (e.g., a web page interface) for use in controlling the communication of data and other functional aspects relating to the home network node 500. A data transport function carries out data transport at the direction of a network-distributed application router. Where data is streamed, a streaming transport function, implemented with a streaming engine, carries out the transport of streaming data. Further, depending upon the nature of the data transfer, real time (RT) or non RT transcoders are implemented to facilitate the transfer, e.g., as typically implemented for audio and/or video communications. A file access manager controls access to files stored at the home network node 500 or at a file storage source available to the home network node (e.g., via a file access interface, such as a USB port). Peripheral device interfaces further provide access to the peripheral devices, such as a set top box (e.g., for video applications), webcam, a UPnP device or other third party application-based device. These approaches discussed with FIG. 5 can be implemented, e.g., in connection with the home nodes 130-N in FIG. 1.

The various embodiments described above and shown in the figures are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For example, the functions carried out by host and home network nodes are selectively moved from host to home and/or home to host node, depending upon the application. This type of approach is consistent, for example, with a network-distributed data router having portions thereof implemented on both a host server and a home node, with the functions of the data router being carried out at one or both of the host and home locations. As another example, the interface provided to remote users may involve certain client-based functions and other implementations at the remote user's network access appliance, such as where the “remote” user is another home user node accessing a different home user node (with software implemented at both nodes). These approaches are implemented in connection with various example embodiments of the present invention. Such modifications and changes do not depart from the true spirit and scope of the present invention that is set forth in the following claims.

What is claimed is:

1. A network communication system for communicating data between a home user-network node and a remote user-network node, the system comprising:
a home user-network node configured and arranged to store data capable of being routed on the network;
a remote user-network node configured and arranged to receive data routed on the network;
a server node on the network; and
a network-distributed application routing controller implemented in the home user-network node and in the server node, with the server node adapted to control routing functions at the home user-network node via the network-distributed application routing controller, the network-distributed application routing controller being configured and arranged to respond to a request for data routing between the home user-network node and the remote user-network node by:
verifying the request as a function of security data provided via the request,
configuring the data for routing, and
administratively controlling the home-user network node and the server node for routing the requested data between the home user-network node and the remote user-network node.

2. The system of claim 1, wherein the network-distributed application routing controller is further configured and arranged to assess communication efficacy for outing the requested data, and for administratively controlling the home-user network node and the server node for routing the requested data between the home user-network node and the remote user-network node as a function of the assessed communication efficacy.

3. The system of claim 2, wherein the network-distributed application routing controller is configured and arranged to assess communication efficacy for routing the requested data from the home user-network node to the remote user-network node by identifying an acceptable data format for use by the remote user-network node, and for configuring the data at the home user-network node for routing to the remote user-network node by formatting the data to the acceptable data format.

4. The system of claim 2, wherein the network-distributed application routing controller is configured and arranged to assess communication efficacy by identifying available communications channels available for transferring the requested data to or from the remote user-network node, and to select one of the identified communications channels over which to pass the requested data.

5. The system of claim 1, wherein the system includes a plurality of the home user-network nodes and a plurality of the remote user-network nodes, and wherein the network-distributed application routing controller is implemented in the plurality of home user-network nodes and the server node.

6. The system of claim 1, wherein the network-distributed application routing controller is configured and arranged to administratively control the home-user network node and the server node for routing the requested data from the home user-network node to the remote user-network node using at least one data routing parameter relative to the remote user-network node.

7. The system of claim 1, wherein the network-distributed application routing controller is configured and arranged to configure the data at the home user-network node for routing to the remote user-network node as a function of bandwidth capabilities of the remote user-network node.

8. The system of claim 1, wherein the network-distributed application routing controller is implemented in the remote user-network node.

9. The system of claim 1, wherein the network-distributed application routing controller is further configured and arranged to administratively control the home-user network node and the server node for routing the requested data between the home user-network node and the remote user-network node as a function of media rights associated with the requested data.

10. The system of claim 1, wherein the network-distributed application routing controller is further configured and arranged to wake a device at the home user-network node from a low power sleep mode to an active awake mode to facilitate the transfer of data with the woken device.

11. The system of claim 1, wherein the network-distributed application routing controller is configured and arranged to respond to a request for routing streaming data from the home user-network node to the remote user-network node by:
verifying the request as a function of security data provided via the remote user-network node,
configuring the data for routing, and
administratively controlling the home-user network node and the server node for routing the streaming data from the home user-network node to the remote user-network node.

12. The system of claim 11, wherein the network-distributed application routing controller is configured and arranged to respond to a request for routing streaming data including live broadcast data received at a device associated with the home user-network node by streaming the live broadcast data from the device to the remote user-network node.

13. The system of claim 11, further comprising a cache configured and arranged to store a portion of the streaming data to facilitate uninterrupted playback of the streaming data at the remote user-network node.

14. The system of claim 1, further comprising a cache configured and arranged to store data on behalf of a user, wherein the network-distributed application routing controller is configured and arranged to administratively control the home-user network node and the server node for routing the requested data between the home user-network node and the remote user-network node by routing data from a device at the home user-network node to the cache, and from the cache to the remote user-network node.

15. The system of claim 1, wherein the server node is further configured and arranged to track the transfer of data between the home user-network node and the remote user-network node.

16. The system of claim 1, wherein the server node is configured and arranged to maintain an account for users and to facilitate the transfer of data on behalf of each user as a function of the maintained account.

17. The system of claim 1, wherein the network-distributed application routing controller is configured and arranged to administratively control the home-user network node and the server node for routing the requested data between the home user-network node and the remote user-network node as a function of regulations associated with a geographical location of at least one of the home user-network node and the remote user-network node.

18. The system of claim 1, wherein the network-distributed application routing controller is configured and arranged to facilitate the transfer of data from the remote user-network node to the home user-network node by:
verifying a request from a user at the remote user-network node for transferring the data as a function of security data provided via the request,
administratively controlling the home-user network node and the server node for routing the requested data from the remote user-network node to the home user-network node.

19. A system for routing content among peer locations in a peer-to-peer network, the system comprising:
a plurality of mobile personal network access appliances configured and arranged to access the peer-to-peer network;
a plurality of home network nodes configured and arranged to store personal content and programmed with a user application router configured to route the personal content on the peer-to-peer network;
a network server configured and arranged to communicate with the mobile personal network access appliances and the home network nodes via the peer-to-peer network, and programmed with a host application router configured to interact with the user application routers to control each home network node for communicating files made available at each home network node; and
wherein the network server is configured and arranged to respond to a request for content from the mobile personal network access appliance by:
authenticating a user at the mobile personal network access appliance as a function of authentication data for the user; and
in response to the request being authenticated, facilitating the communication of the personal content from a corresponding home network node to the mobile personal network access appliance via the peer-to-peer network.

20. The system of claim 19, wherein the home network node is adapted to configure the personal content for use by the mobile personal network access appliance and communicate the configured personal content to the mobile personal network access appliance via the peer-to-peer network.

21. The system of claim 19, wherein the home network node includes at least one storage appliance and at least one home network access appliance.

22. The system of claim 21, wherein the user application router is programmed into the home network access appliance.

23. The system of claim 22, wherein the home network access appliance includes at least one of: a computer, a router and an internet gateway appliance.

24. The system of claim 19, wherein the host application router is adapted to generate, in connection with a user application router at a home network node, an electronic token including information for retrieving data from the home network node, to send the electronic token to a mobile personal network access appliance, and to facilitate, in response to a user at the mobile personal network access appliance implementing the electronic token, the transfer of data from the home network node to the mobile personal network access appliance.

25. A method for routing content among peer locations in a peer-to-peer network including a plurality of mobile personal network access appliances, a plurality of home nodes and a host server, the method comprising:
programming a user application router function into each of the home nodes, the user application router configured and arranged for interacting with the host server for transferring data from the home node to a mobile personal network access appliance; and
in response to a request from one of the mobile personal network access appliances:
verifying the request as a function of authentication data for a user at the mobile personal network access appliance,
in response to the request being verified, providing a network-based interface to the mobile personal network access appliance, the interface providing information describing data available to the mobile personal network access appliance, via one of the home nodes; and
in response to a request for available data from the mobile personal network access appliance, controlling, via the user application router, the home node to transfer data to the peer-to-peer network and routing the data to the mobile personal network access appliance.
